(19) United States
(12) Patent Application Publication
(10) Pub. No.: US 2025/0191084 A1
(43) Pub. Date: Jun. 12, 2025

(54) METHOD AND APPARATUS FOR RESTORATION OF COAL MINE ECOLOGICAL DAMAGE, AND STORAGE MEDIUM AND ELECTRONIC DEVICE

(71) Applicants: CHINA ENERGY SHENDONG COAL GROUP CO., LTD, Erdos City, Inner Mongolia (CN); NATIONAL INSTITUTE OF CLEAN-AND-LOW-CARBON ENERGY, Beijing (CN); CHINA ENERGY INVESTMENT CORPORATION LIMITED, Beijing (CN)

(72) Inventors: Quansheng LI, Beijing (CN); Junting GUO, Beijing (CN); Huayang DAI, Beijing (CN); Kai ZHANG, Beijing (CN); Yueguan YAN, Beijing (CN)

(21) Appl. No.: 18/845,373

(22) PCT Filed: Nov. 25, 2022
(86) PCT No.: PCT/CN2022/134277

§ 371 Date: Sep. 9, 2024

(30) Foreign Application Priority Data
Mar. 10, 2022 (CN) 202210230309.4

(51) Int. Cl. G06Q 50/02

(52) U.S. Cl. CPC G06Q 50/02

(57) ABSTRACT

A method for restoration of coal mine ecological damage, comprising: obtaining mining area basic information; on the basis of the mining area basic information, dynamically simulating earth surface movement and deformation for mining methods at preset time intervals by using a mining subsidence simulation method; on the basis of vegetation information, regional climate features, and dynamic simulation results, obtaining ecological damage degree distribution areas of the mining methods, and determining ecological restoration modes; on the basis of mining benefits, resource recovery rates and ecological management input costs of the mining methods, obtaining comprehensive benefits of the mining methods, and sorting the values of the comprehensive benefits from large to small; and on the basis of the sorting, selecting an ecological restoration mode having the largest comprehensive benefit. Further disclosed are an apparatus for restoration of coal mine ecological damage, and a storage medium and an electronic device.

### CROSS-REFERENCE TO RELATED APPLICATIONS

This application is a U.S. National Stage of International Patent Application No. PCT/CN2022/134277 filed Nov. 25, 2022, which claims priority of Chinese patent application No. 202210230309.4, filed with the CNIPA on Mar. 10, 2022, entitled “method and apparatus for restoration of coal mine ecological damage, and storage medium and electronic device”, the entire contents of which are incorporated herein by reference.

### FIELD

The present application relates to the technical field of ecological environment protection and restoration, and in particular to a method and apparatus for restoration of coal mine ecological damage, and storage medium and electronic device.

### BACKGROUND

The prior art proposes a method to increase the resource recovery rate and reduce the earth surface ecological damage with extra-long working face length, extra-long advancing distance and extra-large mining height. This method has a positive effect on enhancing the production efficiency, reducing the earth surface cracks and bringing the high resource recovery rate, and plays a decisive role in reducing the degree of the damage of the mining. However, since there is no technical method to completely mine the coal seams in an instant, it is impossible to achieve the overall subsidence of the entire mining area, and it is still necessary to adopt a block-by-block method for mining in sequence. This mining method creates permanent boundaries within the mining area. The boundary location will cause relatively large damage to the water, soil and vegetation. Artificial methods are still needed for ecological restoration and management. And, this mining method has specific applicable conditions. For example, it is difficult to apply when the coal seam is thin, the mining depth is small, or the coal seam has a large inclination.

Relevant technologies have a relatively significant effect on the ecological restoration of mining areas under poor soil conditions, and can be used as an aspect of the system of efficient ecological restoration methods after mining damage in mining areas, as well as one of the main methods of ecological restoration after damage. In addition, there are other technologies that relate to vegetation species selection and other aspects, which also play a positive role in promoting ecological restoration. Although these technologies perform ecological management from the perspective of earth surface soil restoration or improvement, they are only passive methods of restoration and management.

Although the above technologies have certain positive effects on the prevention and control of ecological damage in mining areas, they do not systematically consider the mining in mining area and earth surface ecology as a whole, nor do they consider the problem on self-restoration ability of vegetation caused by mining damage at different physiological stages or under the influence of climate.

Therefore, there is a need for a coal mine ecological restoration method that considers the mining in mining area and earth surface ecological restoration as a whole, considers the problem on self-restoration ability of vegetation caused by mining damage at different physiological stages or under the influence of climate, and considers the economic benefits of mining and restoration.

### SUMMARY

The present disclosure provides a method for restoration of coal mine ecological damage, which solves the technical problem that the restoration of coal mine ecological damage does not take into account the influence of different physiological cycles of vegetation and regional climatic conditions. The present disclosure achieves minimal artificial intervention in the restoration of coal mine ecological damage, reduces the extent of the ecological damage caused by mining from the origin of the mining method, and enhances the comprehensive benefits of the restoration of coal mine ecological damage.

The present disclosure provides:
A method for restoration of coal mine ecological damage, comprising:
obtaining mining area basic information, wherein the basic information comprises at least one of geological mining information, various mining methods that meet mining requirements, vegetation information, and regional climate features of a preset period of time; the geological mining information comprises at least one of geological information and mining information; and the vegetation information comprises at least one of earth surface vegetation type and distribution, ecological feature, and self-restoration ability of damaged plant;
based on the mining area basic information, dynamically simulating earth surface movement and deformation for the various mining methods at a preset time interval by using a mining subsidence simulation method;
based on the vegetation information, the regional climate features and results of the dynamic simulation, obtaining ecological damage degree distribution areas of the various mining methods, and determining ecological restoration modes of the ecological damage degree distribution areas;
obtaining mining benefits and resource recovery rates based on the various mining methods, obtaining ecological management input costs of the various mining methods based on the ecological restoration modes, obtaining comprehensive benefits of the various mining methods based on the mining benefits, the resource recovery rates and the ecological management input costs of the various mining methods, and sorting values of the comprehensive benefits from large to small;
based on the sorting, selecting the ecological restoration mode having the largest comprehensive benefit.

In an embodiment of the present disclosure, the preset time interval is set to be a solar term time cycle or a physiological cycle of a plant, wherein the solar term time cycle is set to be less than or equal to 15 days.

In an embodiment of the present disclosure, the preset period of time is set to be greater than or equal to 10 years, and less than or equal to 30 years.

In an embodiment of the present disclosure, the ecological damage degree distribution areas comprise at least one of a plant self-restoration area, an artificially guided restoration area, and an artificially replanted restoration area.

In an embodiment of the present disclosure, the self-restoration ability of damaged plant comprises a self-restoring ability of the vegetation under an influence of at least one of different seasons, rainfalls, and wind speeds.

In an embodiment of the present disclosure, parameters of the earth surface movement and deformation comprise at least one of a subsidence coefficient, a horizontal movement coefficient, a main influence angle tangent, a maximum subsidence angle, and an inflection point offset.

In an embodiment of the present disclosure, the geological information comprises at least one of mining depth, coal seam thickness, stratigraphic dip, structural conditions, and overburden properties; and the mining information comprises at least one of safe production, resource recovery rate, annual mine output, and production efficiency.

The present disclosure provides an apparatus for restoration of coal mine ecological damage, comprising:
module for obtaining basic information, configured for obtaining mining area basic information, wherein the basic information comprises at least one of geological mining information, various mining methods that meet mining requirements, vegetation information, and regional climate features of a preset period of time; the geological mining information comprises at least one of geological information and mining information; and the vegetation information comprises at least one of earth surface vegetation type and distribution, ecological feature, and self-restoration ability of damaged plant;
module for simulating earth surface movement and deformation, configured for, based on the mining area basic information, dynamically simulating earth surface movement and deformation for the various mining methods at a preset time interval by using a mining subsidence simulation method;
module for determining ecological restoration modes, configured for, based on the vegetation information, the regional climate features and the results of dynamic simulation, obtaining ecological damage degree distribution areas of the various mining methods, and determining ecological restoration modes of the ecological damage degree distribution areas;
module for evaluating economic benefit, configured for obtaining mining benefits and resource recovery rates based on the various mining methods, obtaining ecological management input costs of the various mining methods based on the ecological restoration modes, obtaining comprehensive benefits of the various mining methods based on the mining benefits, the resource recovery rates and the ecological management input costs of the various mining methods, and sorting values of the comprehensive benefits from large to small;
module for determining ecological restoration mode, configured for selecting the ecological restoration mode having the largest comprehensive benefit based on the sorting.

The present disclosure provides a storage medium in which a computer program is stored.

When the program is executed by a processor, the steps of the method for restoration of coal mine ecological damage described in any of the above contents are implemented.

The present disclosure provides an electronic device, comprising:
a memory in which a computer program is stored; and
a processor, for executing the computer program stored in the memory to implement the steps of the method for restoration of coal mine ecological damage described in any of the above contents.

Compared with the prior art, one or more embodiments of the present disclosure have the following advantages:

The present disclosure obtains the damage degree distribution of vegetation under different physiological cycles and regional climate conditions by dynamically simulating earth surface movement and deformation of different mining methods, and then makes the benefit evaluation of each mining method and the cost evaluation of ecological damage restoration, and adopts the ecological damage restoration method with the highest comprehensive benefit to perform the restoration of coal mine ecological damage. The method of the present disclosure obtains a damage degree of vegetation under different physiological cycles and regional climate conditions, achieves minimal artificial intervention in the restoration of coal mine ecological damage, reduces the extent of the ecological damage caused by mining from the origin of the mining method, and enhances the comprehensive benefits of the restoration of coal mine ecological damage.

Other features and advantages of the present disclosure will be set forth in the following texts, and, partially become obvious from the description, or may be understood by the implementation of the present disclosure. The objects and other advantages of the present disclosure can be achieved and obtained through the structures particularly pointed out in the specification, claims and drawings.

### DESCRIPTION OF THE DRAWINGS

The drawings are used to provide a further understanding of the present disclosure and form part of the specification, for, together with the embodiments of the present disclosure, explaining the present disclosure and do not constitute a limitation of the present disclosure. In the drawings:

FIG. 1 is a schematic flow diagram of a method for restoration of coal mine ecological damage of embodiment 1 of the present disclosure; and

FIG. 2 is a schematic diagram of a logical framework of an apparatus for restoration of coal mine ecological damage of embodiment 3 of the present disclosure.

### DESCRIPTION OF EXEMPLARY EMBODIMENTS

In order to make the object, technical solution and advantages of the present disclosure clearer, the present disclosure is further described in detail below in conjunction with the accompanying drawings, so that the implementation process of how the present disclosure utilizes technical means to solve technical problems and achieve technical effects can be fully understood and implemented accordingly. It should be noted that as long as there is no conflict, the various embodiments of the present disclosure and the various features in the embodiments can be combined with each other, and the formed technical solutions are all within the protection scope of the present disclosure.

### First Embodiment

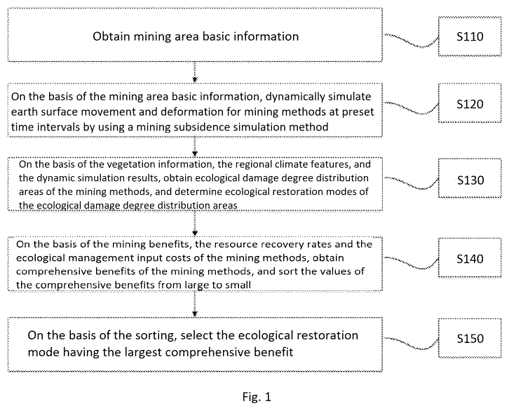

FIG. 1 is a schematic flow diagram of a method for restoration of coal mine ecological damage of this embodiment;

The embodiment provides a method for restoration of coal mine ecological damage, comprising the following steps:

S110, obtaining mining area basic information, wherein the basic information comprises at least one of geological mining information, various mining methods that meet mining requirements, vegetation information, and regional climate features of a preset period of time, the geological mining information comprises at least one of geological information and mining information, and the vegetation information comprises at least one of earth surface vegetation type and distribution, ecological feature, and self-restoration ability of damaged plants. In this embodiment, the geological information comprises at least one of mining depth, coal seam thickness, stratigraphic dip, structural conditions, and overburden properties; and the mining information comprises at least one of safe production, resource recovery rate, annual mine output, and production efficiency.

Specifically, collecting mining area basic data, wherein the basic data comprise mining area basic geological conditions, mining conditions, earth surface vegetation physiological periodic variations, vegetation types and ecological features, regional climate features, mining methods that can meet production requirements, and damage resistance and self-restoration ability of vegetation to earth surface movement and deformation, specifically comprising: \textcircled{1} Geological conditions such as mining depth, coal seam thickness, stratigraphic dip, structural conditions, and overburden properties; \textcircled{2} Production conditions such as safe production, resource recovery rate, annual mine output, and production efficiency; \textcircled{3} Various mining methods or loss-reducing mining methods suitable for actual mining production; \textcircled{4} Types and distribution of earth surface vegetation, as well as physiological features of vegetation and self-restoration ability after damage; \textcircled{4} The regional climate feature of a preset period of time, wherein in this embodiment, the preset period of time is set to be greater than or equal to 10 years, and less than or equal to 30 years.

S120, based on the mining area basic information, dynamically simulating earth surface movement and deformation for various mining methods at a preset time interval by using a mining subsidence simulation method.

Specifically, based on the obtained mining area basic information, carrying out the earth surface subsidence dynamic prediction. According to the actual production requirement of the mining area and relevant laws and regulations, one or several mining methods are preliminarily selected; the mining subsidence simulation method is used to dynamically simulate the earth surface movement and deformation according to the dynamic simulation time nodes at the preset time interval; and a data spatial analysis software is used to make a dynamic simulation diagram of the earth surface movement and deformation. In this embodiment, the preset time interval is set to be a solar term time cycle or a physiological cycle of a corresponding plant on the earth surface, wherein the solar term time cycle is set to be less than or equal to 15 days.

In this embodiment, when carrying out dynamical simulation, selected parameters of the earth surface movement and deformation comprise at least one of a subsidence coefficient, a horizontal movement coefficient, a main influence angle tangent, a maximum subsidence angle, and an inflection point offset.

S130, based on the vegetation information, regional climate features and results of dynamic simulation, obtaining ecological damage degree distribution areas of the various mining methods, and determining ecological restoration modes of the ecological damage degree distribution areas.

Specifically, according to the vegetation type and distribution, ecological feature, and self-restoration ability of damaged plants in the vegetation information, and according to the dynamic simulation results of earth surface subsidence, analyzing the self-restoration ability of plants under the dual influences of physiological state and regional climate feature during the period of vegetation being damaged in different earth surface deformation areas under different mining methods, analyzing the degree and scope of earth surface vegetation damage to obtain the damage degree of vegetation in each area of the mining area surface, and drawing a distribution map of plant damage degree. For the future climate impact, a big data analysis method can be used to predict the climate features of the corresponding preset time period. In this embodiment, the self-restoration ability of damaged plant comprises a self-restoration ability of the vegetation under an influence of at least one of different seasons, rainfalls, and wind speeds.

Areas under self-restoration conditions should try to adopt ecological self-restoration, with a focus on the statistics of the area that cannot be self-restored, such that a cloud map of ecological damage degree distribution is made, and the restoration methods and restoration engineering volume adopted in areas with different damage degrees are determined. In this embodiment, the ecological damage degree distribution areas comprise at least one of a plant self-restoration area, an artificially guided restoration area, and an artificially replanted restoration area.

S140, obtaining mining benefits and resource recovery rates based on the various mining methods, obtaining ecological management input costs of the various mining methods based on the ecological restoration modes, obtaining comprehensive benefits of the various mining methods based on the mining benefits, the resource recovery rates and the ecological management input costs of the various mining methods, and sorting values of the comprehensive benefits from large to small.

Specifically, the mining benefits are calculated according to the various mining methods preliminarily selected above, and the resource recovery rate is calculated. Then, the vegetation restoration engineering volume is calculated according to the vegetation restoration modes under different mining methods, and then the ecological governance input costs such as restoration and management and maintenance of each mining method are obtained. According to the mining economic benefits, resource recovery rate, and ecological governance input costs of each mining method, the comprehensive benefits of each mining method and the corresponding ecological governance costs are obtained. The values of the comprehensive benefits of each plan are sorted from large to small, and perform a comparative analysis of the economic benefits.

S150, based on the sorting, selecting the ecological restoration mode having the largest comprehensive benefit.

Specifically, the ecological restoration method with the greatest comprehensive benefit is selected according to the sorting, and the mining loss reduction method and earth surface ecological restoration methods are determined at the same time. After determining the preferred scheme, layout is planned and restoration is accurately performed. It may make a comparison diagram of the mining benefits, ecological governance costs and resource recovery rates under various mining methods, and then select the final mining method and ecological restoration method according to the scheme with the greatest comprehensive benefit. Then, according to the determined mining method, carrying out the development deployment, and according to the influence of mining simulates earth surface subsidence results and the determined restoration method. The restoration timing and restoration material preparation are planned in advance to achieve scientific, effective and precise restoration.

This embodiment takes “underground mining in the mining area-damage transfer between overburden and the earth surface-damage resistance of earth surface vegetation under different physiological stages and climatic conditions” as the overall prevention and control of the mining area production-ecological system, taking into account mining benefits and ecological governance costs, and taking safe production and benefit returns as the final evaluation basis. With mining origin (coal mining) damage control as the basic means, damage transfer (overburden and earth surface movement and deformation) regulation as the auxiliary method, and terminal (vegetation) restoration and management as the remedial measure, comprehensive prevention and control of mining area ecological damage is carried out.

This embodiment collects basic information on the basic geological and mining factors of the mining area, the physiological periodic changes of earth surface vegetation, and the resistance and restoration ability of vegetation to earth surface movement and deformation, combined with the predicted results of earth surface movement and deformation of the optional mining methods in the mining area, analyzes the self-restoration ability of earth surface vegetation under the influence of different physiological stages and climate dual factors, and selects specific mining methods and processes, earth surface ecological restoration measures and restoration timing according to the overall damage degree and damage range of the earth surface mining impact area, and mining benefits, damage governance investment, resource recovery rate. Within a reasonable range of economic benefits, priority shall be given to mining methods with significant damage reduction effects, supplemented by small-range manual restoration and maintenance.

This embodiment fully considers the difference in the ability of plants to resist damage in different physiological periods, takes into account the impact of climate and environment on the self-restoration of damaged plants, takes mining reduction as the basic method, reduces the mining damage degree from the mining origin, and supplements it with small-range precise restoration measures on the earth surface, which not only achieves ecological protection, but also achieves the mining requirements of high efficiency and high recovery rate. It provides a scientific reference method for the ecological reduction design and mining planning in mining areas.

This embodiment aims to use the technical means of minimum production cost and minimum ecological damage as the optimal prevention and control method for mining area production-ecosystem damage, so as to achieve the plateau state maintenance effect of mining area ecology under the minimum human intervention measures, and achieve the purpose of mining area ecological protection.

The advantages of this embodiment in terms of technical solutions and the steps of disclosure, compared with existing patents, are:
(1) This embodiment considers mining in area mining and damage management as a system, while prior art technologies only focus on one aspect or one technical means;
(2) This embodiment uses the damage resistance ability of plants under different physiological periods and climate influences as a prevention and control technology selection indicator, which has a guiding role in the overall planning of mining areas; but prior art technologies do not consider this factor;
(3) This embodiment uses the economic benefits and resource recovery rate of the selected prevention and control scheme as determined indicators for the prevention and control method, taking into account the cost and having practical operability; but prior art technologies do not consider this factor;
(4) This embodiment takes mining origin damage reduction as the basic approach, fully utilizing the ecological self-restoration ability as the principle of the original ecological succession of vegetation, and minimizing human intervention. The method of this embodiment is mainly applicable to ecological prevention and control in unmined areas or newly built mines.

Specifically, the beneficial effects of this embodiment compared with the prior art are as follows:
First, this embodiment considers underground resource mining and earth surface ecology as a complete mining damage system, making the damage reduction, damage control and damage restoration measures brought by mining more scientific and systematic, rather than taking specific measures for one aspect but ignoring the specific applicable conditions, avoiding the one-sidedness of engineering and technical problem analysis, highlighting the systematic nature of problem analysis. No relevant similar systematic thinking or research materials have been retrieved, which reflects the creative value of this embodiment.
Secondly, this embodiment takes into account the physiological features of plants, comprising the differences between different species or populations of plants and the differences in the stress resistance of individual vegetative growth (root, stem, leaf growth) of plant and reproductive growth (differentiation of flower buds, flowering, fruiting) stages, and comprehensively considers the physiological conditions of plants under the influence of climate (flood season, dry season, sunshine and wind speed, etc.), so that the analysis of vegetation damage in the dynamic mining process is more accurate and reliable. Compared with the current ecological restoration and impact analysis methods, this embodiment incorporates plant physiology and climate impacts into mining impact analysis for the first time, and the method of this embodiment has scientific and novel analysis.
Thirdly, this embodiment provides a specific restoration and management method through self-restoration ability judgment, by the systematic summary of the basic data in the early stage and the damage impact analysis of various applicable mining methods, as well as comprehensive analysis of the effects of plants under different physiological and climatic influences, and uses mining benefits, ecological restoration and management investment and resource recovery rate as the basis for the final mining and restoration and management selection, which has clear specific practicality and operability.

In Summary, this embodiment obtains the damage degree distribution of vegetation under different physiological cycles and regional climate conditions by dynamically simulating earth surface movement and deformation of different mining methods, and then makes the benefit evaluation of each mining method and the cost evaluation of ecological damage restoration, and adopts the ecological damage restoration method with the highest comprehensive benefit to perform the restoration of coal mine ecological damage. The method of this embodiment obtains a damage degree of vegetation under different physiological cycles and regional climate conditions, achieves minimal artificial intervention in the restoration of coal mine ecological damage, reduces the extent of the ecological damage caused by mining from the origin of the mining method, and enhances the comprehensive benefits of the restoration of coal mine ecological damage.

### Second Embodiment

This embodiment uses the Daliuta Coal Mine in Shendong Mining Area as the application object.

### Step 1: Collect Relevant Information.

Geological mining data: The earth surface is mainly wind-blown sand accumulation, with a small amount of loess mounds; the 2-2 coal seam is buried about 100 m deep, the 5-2 coal is buried about 200 m deep, the coal thickness is generally 4 m to 8 m, the stratigraphic dip is generally less than 3°, and the overburden is mainly sandstone.

Earth surface vegetation: 59 species of plants in 23 families are found in the area, and the plant types are mainly shrubs and herbaceous vegetation, with less tree vegetation. According to the characteristics of regional species, this analysis focuses on six types of vegetation, i.e., Salix psammophila, Caragana korshinskii, Artemisia desertorum, Populus, Melilotus albus, and Hedysarum scoparium as the analysis objects.

Climate environment: local meteorological data for the past 30 years.

Vegetation self-restoration ability: according to on-site measurements and previous research, collecting self-restoration ability data for Salix psammophila, Caragana korshinskii, Artemisia desertorum, Populus, Melilotus albus, and Hedysarum scoparium under different seasons, rainfalls, and wind speeds.

Production requirements: Daliuta Coal Mine is one of Shendong's main production mines. Its production efficiency and capacity will affect the group's economic benefits and the living standards of employees. For this reason, it is required to adopt high-yield and high-efficiency production processes for mining. Some mining (strip mining, limited thickness mining) cannot meet the efficiency and capacity requirements. As for filling mining, in addition to its high cost, the worse thing is that its efficiency cannot meet the production requirement. For this reason, only high-yield and high-efficiency production methods can be selected to optimize mining to achieve damage reduction and ecological restoration and management.

Estimated parameters of earth surface movement: according to the previous earth surface movement observation results, the estimated parameters of earth surface movement of Daliuta Coal Mine are collected by referring to the following parameters: subsidence coefficient: 0.68-0.76, horizontal movement coefficient: 0.14-0.24, main influence angle tangent: 1.55-2.2, maximum subsidence angle: 88°-88.3°, inflection point offset distance: 47-55 m. Appropriate adjustments shall be made according to relevant technical regulations under repeated mining conditions.

### Step 2: Dynamic Prediction of Earth Surface Subsidence.

According to production requirements and prior art technical features, a comprehensive mechanized high-mining mining method can be used, which is divided into two mining methods. One is to use a traditional mining method, with a working face length of 300 m, a advancing length of 4547 m, and a working face mining speed of 10.0 m/d; the other one is to optimize mining parameters for mining, with a working face length of 300 m, a advancing length of 4547 m, and a working face mining speed of 11.5 m/d. The mining continuation was scheduled from September of 2011 to February of 2013. According to the solar terms, every 15 days was set to be an estimated time node. From September of 2011 to August of 2013, the movement and deformation degree of the earth surface and the affected area under the two mining methods were estimated. According to the big data analysis of meteorological data, the meteorological conditions such as rainfall and wind speed from September 2011 to August 2013 were predicted, combined with the damage degree and affected area of the six plants analyzed in detail under the comprehensive influence of mining damage, climate impact and self-restoration ability. Relevant charts were drawn.

Step 3: Analysis of vegetation damage degree.

According to the comprehensive influence results of step 2, making statistics of damaged vegetation types, damage degree and damaged area. According to plant physiological features, determining restoration measures by region, and calculating restoration engineering volume and related costs.

### Step 4: Comparative Analysis of Economic Benefits.

Comparing the coal mining benefit, ecological governance investment and recovery rate under the two mining methods.

### Step 5: Determining the Preferred Scheme, Plan Layout, and Accurately Restoring.

According to the comprehensive benefits and self-restoration ratio, comprehensively determining the mining method, restoration measures and restoration timing. This embodiment adopts a working face length of 300 m, a advancing length of 4547 m, a working face mining speed of 11.5 m/d and a comprehensive mechanized caving method. For the earth surface restoration, manual maintenance is adopted in the lightly damaged area, and for the severely damaged area, vegetation is replanted after the mining influence.

### Third Embodiment

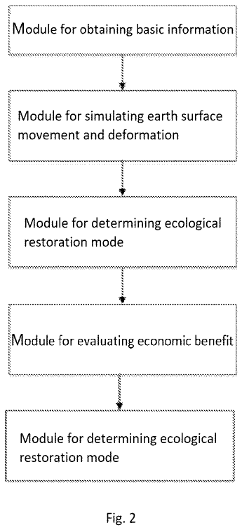

FIG. 2 is a schematic diagram of a logical framework of an apparatus for restoration of coal mine ecological damage of the present embodiment.

The present disclosure provides an apparatus for restoration of coal mine ecological damage, comprising:
module for obtaining basic information, configured for obtaining mining area basic information, wherein the basic information comprises at least one of geological mining information, various mining methods that meet mining requirements, vegetation information, and regional climate features of a preset period of time, the geological mining information comprises at least one of geological information and mining information, and the vegetation information comprises at least one of earth surface vegetation type and distribution, ecological feature, and self-restoration ability of damaged plant;
module for simulating earth surface movement and deformation, configured for, based on the mining area basic information, dynamically simulating earth surface movement and deformation for the various mining methods at a preset time interval by using a mining subsidence simulation method;
module for determining ecological restoration modes, configured for, based on the vegetation information, the regional climate features and the results of dynamic simulation, obtaining ecological damage degree distribution areas of the various mining methods, and determining ecological restoration modes of the ecological damage degree distribution areas;
module for evaluating economic benefit, configured for obtaining mining benefits and resource recovery rates based on the various mining methods, obtaining ecological management input costs of the various mining methods based on the ecological restoration modes, obtaining comprehensive benefits of the various mining methods based on the mining benefits, the resource recovery rates and the ecological management input costs of the various mining methods, and sorting values of the comprehensive benefits from large to small;
module for determining ecological restoration mode, configured for selecting the ecological restoration mode having the largest comprehensive benefit based on the sorting.

In Summary, this embodiment obtains the damage degree distribution of vegetation under different physiological cycles and regional climate conditions by dynamically simulating earth surface movement and deformation of different mining methods, and then makes the benefit evaluation of each mining method and the cost evaluation of ecological damage restoration, and adopts the ecological damage restoration method with the highest comprehensive benefit to perform the restoration of coal mine ecological damage. The apparatus of this embodiment obtains a damage degree of vegetation under different physiological cycles and regional climate conditions, achieves minimal artificial intervention in the restoration of coal mine ecological damage, reduces the extent of the ecological damage caused by mining from the origin of the mining method, and enhances the comprehensive benefits of the restoration of coal mine ecological damage.

### Fourth Embodiment

The present disclosure provides a storage medium in which a computer program is stored.

When the program is executed by a processor, the steps of the method for restoration of coal mine ecological damage described in any of the above contents are implemented.

Those skilled in the art should understand that the embodiments of the present disclosure can be provided as methods, systems, or computer program products. Therefore, the present disclosure can take the form of a pure hardware embodiment, a pure software embodiment, or an embodiment that integrates software and hardware. Moreover, the present disclosure can take the form of a computer program product implemented on one or more computer-usable storage medium (comprising, but not limited to, disk memory, CD-ROM, optical memory and the like) containing computer-usable program codes.

Those of ordinary skill in the art can understand that all or part of the processes in the above-mentioned embodiment methods can be completed by instructing the relevant hardware through a computer program, and the computer program can be stored in a non-volatile computer-readable storage medium. When being executed, the computer program may comprise the processes of the embodiments of the above-mentioned methods. Among them, any reference to memory, storage, database or other medium used in the embodiments provided in this application may comprises non-volatile and/or volatile memory. The non-volatile memory may comprise read-only memory (ROM), programmable ROM (PROM), electrically programmable ROM (EPROM), electrically erasable programmable ROM (EEPROM) or flash memory. The volatile memory may comprise random access memory (RAM) or external cache memory. By way of illustration and not limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), Rambus direct RAM (RDRAM), direct Rambus dynamic RAM (DRDRAM), and Rambus dynamic RAM (RDRAM) and the like.

### Fifth Embodiment

The present disclosure provides an electronic device, comprising:
a memory in which a computer program is stored; and
a processor, for executing the computer program stored in the memory to implement the steps of the method for restoration of coal mine ecological damage described in any of the above contents.

The present disclosure is described with reference to flowchart and/or block diagram of methods, apparatus (systems), and computer program products according to embodiments of the present disclosure. It should be understood that each process and/or block in the flowchart and/or block diagram, as well as the combination of processes and/or blocks in the flowchart and/or block diagram, can be implemented by computer program instructions. These computer program instructions can be provided to a processor of a general-purpose computer, a special-purpose computer, an embedded processor, or other programmable data processing apparatus to produce a machine, so that the instructions executed by the processor of the computer or other programmable data processing device produce an apparatus for implementing the functions specified in one or more processes in the flowchart and/or one or more blocks in the block diagram.

These computer program instructions may also be stored in a computer-readable memory that can guide a computer or other programmable data processing apparatus to operate in a specific manner, so that the instructions stored in the computer-readable memory produce a product comprising an instruction apparatus, which implements the function specified in one or more processes of the flowchart and/or one or more blocks of the block diagram.

These computer program instructions can also be loaded onto a computer or other programmable data processing apparatus, so that a series of operating steps are performed on the computer or other programmable apparatus to produce the processing implemented by computer, so that the instructions executed on the computer or other programmable device provide steps for implementing the functions specified in one or more processes of the flowchart and/or one or more blocks of the block diagram.

Although the implementations of the present disclosure are disclosed as above, the contents described are only implementations adopted for the convenience of understanding the present disclosure, but not intended to limit the present disclosure. Any technician in the technical field of the present disclosure may make any modifications and changes in the form and details of the implementation without departing from the spirit and scope disclosed in the present disclosure. The protection scope of the present disclosure is not limited to the specific embodiments disclosed herein, but includes all technical solutions falling within the scope of the claims.

1. A method for restoration of coal mine ecological damage, comprising:
obtaining mining area basic information, wherein the basic information comprises at least one of geological mining information, various mining methods that meet mining requirements, vegetation information, and regional climate features of a preset period of time; the geological mining information comprises at least one of geological information and mining information; and the vegetation information comprises at least one of earth surface vegetation type and distribution, ecological feature, and self-restoration ability of damaged plant;
based on the mining area basic information, dynamically simulating earth surface movement and deformation for the various mining methods at a preset time interval by using a mining subsidence simulation method;
based on the vegetation information, the regional climate features and results of the dynamic simulation, obtaining ecological damage degree distribution areas of the various mining methods, and determining ecological restoration modes of the ecological damage degree distribution areas;
obtaining mining benefits and resource recovery rates based on the various mining methods, obtaining ecological management input costs of the various mining methods based on the ecological restoration modes, obtaining comprehensive benefits of the various mining methods based on the mining benefits, the resource recovery rates and the ecological management input costs of the various mining methods, and sorting values of the comprehensive benefits from large to small; and
based on the sorting, selecting the ecological restoration mode having the largest comprehensive benefit.

2. The method according to claim 1, wherein the preset time interval is set to be a solar term time cycle or a physiological cycle of a plant, wherein the solar term time cycle is set to be less than or equal to 15 days.

3. The method according to claim 2, wherein the preset period of time is set to be greater than or equal to 10 years, and less than or equal to 30 years.

4. The method according to claim 3, wherein the ecological damage degree distribution areas comprise at least one of a plant self-restoration area, an artificially guided restoration area, and an artificially replanted restoration area.

5. The method according to claim 2, wherein the self-restoration ability of damaged plant comprises a self-restoration ability of the vegetation under an influence of at least one of different seasons, rainfalls, and wind speeds.

6. The method according to claim 2, wherein parameters of the earth surface movement and deformation comprise at least one of a subsidence coefficient, a horizontal movement coefficient, a main influence angle tangent, a maximum subsidence angle, and an inflection point offset.

7. The method according to claim 1, wherein the geological information comprises at least one of mining depth, coal seam thickness, stratigraphic dip, structural conditions, and overburden properties; and the mining information comprises at least one of safe production, resource recovery rate, annual mine output, and production efficiency.

8. (canceled)

9. A storage medium in which a computer program is stored, wherein when the program is executed by a processor, the steps of the method for restoration of coal mine ecological damage of claim 1 are implemented.

10. An electronic device, comprising:
a memory in which a computer program is stored; and
a processor, for executing the computer program stored in the memory to implement the steps of the method for restoration of coal mine ecological damage of claim 1.

11. The storage medium according to claim 9, wherein the preset time interval is set to be a solar term time cycle or a physiological cycle of a plant, wherein the solar term time cycle is set to be less than or equal to 15 days.

12. The storage medium according to claim 11, wherein the preset period of time is set to be greater than or equal to 10 years, and less than or equal to 30 years.

13. The storage medium according to claim 12, wherein the ecological damage degree distribution areas comprise at least one of a plant self-restoration area, an artificially guided restoration area, and an artificially replanted restoration area.

14. The storage medium according to claim 11, wherein the self-restoration ability of damaged plant comprises a self-restoration ability of the vegetation under an influence of at least one of different seasons, rainfalls, and wind speeds.

15. The storage medium according to claim 11, wherein parameters of the earth surface movement and deformation comprise at least one of a subsidence coefficient, a horizontal movement coefficient, a main influence angle tangent, a maximum subsidence angle, and an inflection point offset.

16. The storage medium according to claim 9, wherein the geological information comprises at least one of mining depth, coal seam thickness, stratigraphic dip, structural conditions, and overburden properties; and the mining information comprises at least one of safe production, resource recovery rate, annual mine output, and production efficiency.

17. The electronic device according to claim 10, wherein the preset time interval is set to be a solar term time cycle or a physiological cycle of a plant, wherein the solar term time cycle is set to be less than or equal to 15 days.

18. The electronic device according to claim 17, wherein the preset period of time is set to be greater than or equal to 10 years, and less than or equal to 30 years.

19. The electronic device according to claim 18, wherein the ecological damage degree distribution areas comprise at least one of a plant self-restoration area, an artificially guided restoration area, and an artificially replanted restoration area.

20. The electronic device according to claim 17, wherein the self-restoration ability of damaged plant comprises a self-restoration ability of the vegetation under an influence of at least one of different seasons, rainfalls, and wind speeds.

21. The electronic device according to claim 17, wherein parameters of the earth surface movement and deformation comprise at least one of a subsidence coefficient, a horizontal movement coefficient, a main influence angle tangent, a maximum subsidence angle, and an inflection point offset.
